(19) United States
(12) Patent Application Publication
(10) Pub. No.: US 2008/0088056 A1
(43) Pub. Date: Apr. 17, 2008

(54) Flexible release agent-free, multiple-use materials employed for concrete pouring forms and methods of making and using the same

(75) Inventors: Frank A. Vavra, Alexandria, VA (US); Mary Francis Vavra Alcoser, Linthicum, MD (US); Steven R. Maimon, Alexandria, VA (US); Victor H. Klein III, Alexandria, VA (US)

Correspondence Address: FOLEY AND LARDNER LLP;SUITE 500, 3000 K STREET NW, WASHINGTON, DC, 20007, US

(73) Assignee: Maxam Industries Inc.

(21) Appl. No.: 11/806,672

(22) Filed: Jun. 1, 2007

Related U.S. Application Data
(60) Provisional application No. 60/810,156, filed on Jun. 2, 2006.

(51) Int. Cl. B32B 37/14

(52) U.S. Cl. 264/213; 156/390; 249/1

(57) ABSTRACT

A concrete form including a rigid substrate having at least one of a flat and curved surface, which are presented to poured concrete, and a flexible membrane lining at least the one flat or curved surface of the rigid substrate so as to have at least one flat or curved surface due to the respective flat or curved surface of the rigid substrate. In some embodiments, at least a portion of the flexible membrane comes into contact with the poured concrete, whereupon the cured concrete may be separated from the concrete form, in the absence of a release agent, to provide one or more corresponding flat or curved surfaces on the cured concrete, which surfaces require little to no finishing work.

CROSS REFERENCE TO RELATED APPLICATIONS

This application claims priority to U.S. Provisional Application No. 60/810,156, filed Jun. 2, 2006, and reference is made to U.S. Provisional Application No. 60/559,005, filed Apr. 5, 2004 and U.S. application Ser. No. 11/098,542, filed Apr. 5, 2005 (Published as US-2006-0275600-A1, Dec. 7, 2006), the disclosures of which are incorporated herein by reference in their entireties.

### BACKGROUND OF THE INVENTION

1. Field of the Invention

The present invention relates generally to flexible materials for concrete pouring applications and, in particular, to concrete forms comprising such materials, methods of making the laminated panels and the use of the laminated panels as concrete pouring forms.

2. Related Art

It is very desirable to form concrete utilizing curved forms to enhance the architectural appearance of the finished concrete product and/or for structural reasons, etc. Such curved forms may be made from material that may be shaped to obtain the desired curved shapes in the finished concrete product. Plywood/carved wood and similar non-metal products (e.g., BB Plyform and HDO/MDO Overlay with a resin-impregnated paper laminated onto a plywood or particle board substrate), as well as aluminum and steel, with the required structural properties in sheets typically are used to construct forms into which concrete is poured to allow for setting and curing of the concrete into specific shapes and dimensions. Typically in such applications, the face of the form that will be in contact with the poured concrete needs to be coated with a release agent, for example, form or diesel or other oil, so that the concrete does not stick to the form during curing, thus permitting the form to be removed from the concrete after it is cured without damage to the surface of the concrete or the form itself, and thus permitting the form to be used again for additional pours.

Plain plywood and metal sheets employed for concrete forming require the use of a release agent for each pour. Construction industry experience indicates that treated concrete forming products typically require a release agent after a limited number of pours, typically less than five, due to adherence of the concrete to the surface and damage to the overlay. The protective covering laminated on to the substrate (e.g., resin-impregnated paper) is very thin and of a material that is susceptible to physical damage by the alkalinity of the concrete mix and by the presence of sand, gravel, and other aggregates in the concrete mix and normal handling of the form at the construction site.

The disadvantages of using these types of products for concrete pouring, versus a durable form that does not require a release agent, include primarily: 1) the additional time and labor required to apply the release agent to form and then to clean the release agent from the form after it is removed from the cured concrete; 2) the additional time and labor required to clean any residual release agent, or staining caused by the release agent, from the surface of the cured concrete after the form is removed; 3) the potential additional time, labor and materials required to repair damage, if any, to the surface of the cured concrete after the form is removed, which damage is caused by failure of the release agent, if any, to provide effective release from the surface of the cured concrete; 4) the potential eventual damage to the form caused by the alkalinity of the concrete mix and the presence of sand, gravel and other aggregates in the concrete mix and the chemicals in the release agent, limiting the useful life of the form and thus increasing the number of forms that need to be purchased and then disposed of; and 5) the potential environmental and related impacts resulting from the use of the release agent, including exposure of workers to the oils, contamination of the construction site, the time, labor, and cost of remediation of the site, and fines imposed by OSHA and/or EPA associated with any such exposure and/or contamination.

In recent years, in attempts to eliminate, or at least to mitigate significantly, the problems inherent in current pouring form products, as indicated above, various other materials have been employed as pouring surfaces laminated onto the appropriate substrates. These other materials include primarily polyethylene, polypropylene and polyurethane, fiberglass resin (with and without the glass scrim), and various engineered polymers. Construction industry experience indicates that these materials typically also require a release agent after a limited number of pours, typically less than ten pours, and/or are not cost-competitive with current pouring forms and the practices for using them.

### SUMMARY OF INVENTION

The inventors of the present invention have developed durable concrete pouring forms utilizing flexible membraines which may be used to form concrete products having curved surfaces that exhibit excellent release properties, even with surfaces having detailed textures and designs, including detailed curved textures and designs, and that could be reused repeatedly without the use of a release agent, and that are cost-competitive with current pouring forms and the practices for using them.

Some embodiments of the present invention utilize flexible membranes having surface energy of less than or approximately equal to about 25 or 30 dynes/cm. The flexible membranes, at least once applied in the forms, may exhibit the desired release characteristics for at least 20, 25, 30 and/or 30+ concrete pours without using a release agent.

In another aspect, the invention provides a method of making a laminated panel useful in concrete pouring applications. The method includes the actions of providing a flexible membrane, providing a substrate including one or more curved surfaces, bonding the sheet to the substrate so as to impart a curved surface onto the flexible membrane, the curved surface corresponding to the curved surface on the substrate, to provide a form that may be released from cured concrete without using a release agent such that at least one surface of the form and at least one surface of the cured concrete are left smooth and undamaged. The flexible membrane may be bonded to the substrate using an adhesive.

In another embodiment of the present invention, there is a method of pouring concrete into a form to be cured. The method includes the steps of lining a form into which concrete is to be poured with a flexible membrane, and pouring concrete into the lined form. The flexible membrane may be separated from the cured concrete without using a release agent, leaving faces of the flexible membrane and the cured concrete previously in contact with each other smooth and undamaged.

In still another aspect, the invention provides a method of making a form useful in concrete pouring applications. The method includes the steps of configuring a form lined with a flexible membrane into which concrete may be poured. The flexible membrane is capable of being released from cured concrete without using a release agent, leaving faces of the flexible membrane and the cured concrete previously in contact with each other smooth and undamaged.

In an exemplary embodiment of the present invention, there is a concrete form including a rigid substrate having at least one of a flat and curved surface, which are presented to poured concrete, and a flexible membrane lining at least the one flat or curved surface of the rigid substrate so as to have at least one flat or curved surface due to the respective flat or curved surface of the rigid substrate. In some embodiments, at least a portion of the flexible membrane comes into contact with the poured concrete, whereupon the cured concrete may be separated from the concrete form, in the absence of a release agent, to provide one or more corresponding flat or curved surfaces on the cured concrete, which surfaces require little to no finishing work.

In another embodiment of the present invention, there is a method of forming concrete comprising pouring concrete into a concrete form, allowing the poured concrete to cure, and separating the concrete form from the cured concrete, provided that at least a portion of the poured concrete comes into contact with a liner of the concrete form, which liner comprises a flexible membrane.

In another embodiment of the present invention, there is a method of manufacturing a concrete form, comprising positioning a rigid substrate having at least one of a flat and curved surface, which are presented to poured concrete, and positioning a flexible membrane over at least the one flat or curved surface of the rigid substrate so that the positioned flexible membrane has at least one flat or curved surface due to the respective flat or curved surface of the rigid substrate, wherein the form is adapted to permit poured concrete to come into contact with at least a portion of the flexible membrane, wherein the flexible membrane is adapted to remain in contact with the poured concrete at least until the concrete becomes substantially cured concrete, and wherein the form is adapted so that the substantially cured concrete can be separated from the concrete form, in the absence of a release agent, to provide one or more corresponding flat or curved surfaces on the cured concrete, which surfaces require little to no finishing work.

### BRIEF DESCRIPTION OF THE DRAWINGS

FIG. 1 is an isometric view of a concrete form according to an embodiment of the present invention.

FIG. 2 is a cross-sectional view of a concrete form according to an embodiment of the present invention.

FIG. 3 is a close-up view of a portion of the cross-sectional view of FIG. 3.

FIG. 4 is an isometric view of a concrete form according to an embodiment of the present invention.

FIG. 5 is a photo of an experimental form according to an embodiment of the present invention.

### DETAILED DESCRIPTION OF SOME EMBODIMENTS OF THE PRESENT INVENTION

The present invention is directed to concrete forms comprising a flexible membrane bonded to a surface of an appropriate substrate, methods of making the concrete forms, and the use of the concrete forms to form concrete structures.

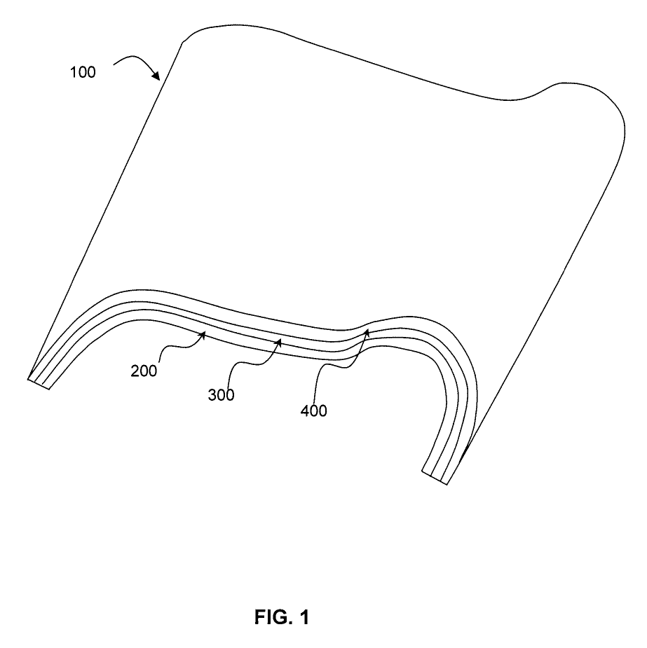

FIG. 1 presents an isometric view of a concrete form 100 according to an embodiment of the present invention. Concrete form 100 includes a flexible membrane 200 bonded to a surface of a rigid substrate 400 by an adhesive layer 300. In some embodiments of the present invention, the flexible membrane 200 is positioned on/within the form 100 to line the substrate 400 so as to have one or more curved working surfaces (i.e., the surfaces that contact the concrete). Such curved surfaces may be supported by corresponding curved surfaces on the substrate 400 which may be, in turn, bonded to the flexible membrane 200, thus “generating” the curved working surfaces of the substrate 200.

Specific details of some of the exemplary embodiments of the present invention will now be described, along with some exemplary scenarios of making and using concrete forms according to the present invention.

In some embodiments of the present invention, the flexible membrane 200 includes ethylene propylene and a diene monomer and/or a terpolymer of ethylene, propylene and a diene monomer. In some embodiments of the present invention, the flexible membrane 200 includes a polymer comprising butylene monomers and/or a polymer comprising chlorosulfonated polyethylene, such as, by way of example only and not by way of limitation, Hypalon®. In some embodiments of the present invention, the flexible membrane comprises an elastomer, a vulcanizable elastomer, a vulcanized elastomer, a poly-rubber blend. In some embodiments of the present invention, the flexible membrane 200 includes a combination/mixture of at least some of these compositions. In some embodiments of the present invention, the flexible membrane 200 is in accordance with ASTM-D-1418-64. In some embodiments of the present invention, the flexible membrane 200 includes any material that may be shaped to have a curved surface to produce a concrete product with the mold 100 having a curved surface, the flexible membrane 200 having a desirable surface finish, a desirable surface hardness, and desirable release characteristics (from concrete) that allow the flexible membrane to be utilized to practice the present invention. In some embodiments of the present invention, the flexible membrane is a rubber product.

The flexible membrane 200 according to an embodiment of the present invention provides easy, quick, and clean release from cured concrete without the use of a release agent, such as form oil or diesel oil or chemicals, of either a barrier or reactive type. Concrete forms comprising the flexible membrane may be used to construct reusable concrete pouring forms. By way of example only and not by way of limitation, the concrete pouring form may be usable for, in some embodiments, at least 20 pours, at least 25 pours, at least 30 pours, and in some embodiments even more than 30 pours, without release agents. In some embodiments of the present invention, the quick, easy, and clean release properties of the flexible membrane 200 are such that the surfaces of both the cured concrete and the flexible membrane 200 may be smooth and undamaged after the concrete form 100 is removed from the cured concrete and/or visa-versa. The concrete forms 100 may be used to construct and disassemble concrete pouring forms using commercially available building and constructions industry tools, equipment, and standard practices.

Without being bound to theory, it is believed that the quick, easy, and clean release capability of the flexible membrane 200 without release agents of some embodiments of the present invention is provided at least in part by the low surface energy of the flexible membrane. The low surface energy may result from the combination of the types and amounts of material employed in the flexible membrane 200 and the method by which the flexible membrane is manufactured. Surface energy may be determined, for example, by measuring the contact angle formed by a droplet of distilled water upon the membrane 200. The more that the water droplet “beads up,” the greater the contact angle is, and the lower the corresponding surface energy is.

In some embodiments of the present invention, such as, by way of example only and not by way of limitation, embodiments utilizing ethylene propylene and a diene monomer and/or a terpolymer of ethylene, propylene and a diene monomer, it is possible to remove residual concrete mineral dust, if any, from, and perform a general cleaning of, the surface of the flexible membrane by simple hand-dusting with a cloth, or rinse with water employing a cloth or brush (e.g., commercially available non-metal bristle brushes), as appropriate, after the form is removed from the cured concrete. Some embodiments of the present invention may incorporate, in the flexible membrane 200, functional or decorative surface textures, patterns, or designs, which surface treatments also do not require the use of release agents for quick, easy, and clean release or any change in the method of cleaning as set forth above. In some embodiments of the present invention, the flexible membrane 200 has a thickness of at least approximately 40 mils which is about the typical minimum thickness of an EPDM rubber roofing membrane, which, in some embodiments of the present invention, constitutes the flexible membrane 200, without affecting the performance of the material as regards: 1) quick, easy and clean release of the form from cured concrete without release agents, and 2) durability of the material for commercial concrete pouring purposes for at least 20, 25, 30 and/or 30 plus pours. In other embodiments of the present invention, thicker or thinner flexible membranes may be utilized as long as the membrane may be used to practice the present invention.

The substrate 400 may be a plywood/carved wood, etc., component or other celluloid, metal, or composite material that complies with the structural, dimensional stability, and other performance specifications required by the building and construction industry for concrete forming products, for example, APA-rated plywood, especially as it relates to forming concrete products with curves. In some embodiments of the present invention, any material may be used as the substrate 400 as long as it permits the present invention to be practiced. In some embodiments of the present invention, the substrate includes plywood, particle board, oriented strand board, rigid and foamed polymers, metal, such as, for example aluminum, composite material, or combinations thereof.

The adhesive layer 300 may be any adhesive that may be used to bond the flexible membrane 200 to the substrate 400. By way of example only and not by way of limitation, an adhesive according to U.S. Pat. No. 4,657,958 to Feldhouse, et al., issued Apr. 14, 1987, the contents of which are incorporated herein in their entirety, may be utilized to bond a membrane 200 made of EPDM to a substrate 400 made of wood and/or metal. Other adhesives may be utilized as well. Some embodiments of the present invention may be practiced utilizing adhesive number 92256 obtainable from Portals Plus Inc. of Chicago, Ill., U.S.A. Any adhesive or other substance that may be utilized to sufficiently connect a flexible membrane 200 to the substrate 400 may be used to practice the present invention. In this regard, by way of example only, and not by way of limitation, nails or screws might be utilized, at least when the portions of the nails or screws would not leave an impression in the concrete product (e.g., nails may be utilized to secure portions of the membrane 200 that do not come into contact with the concrete to the substrate 400, nail heads may be “covered over” with a patch, etc). In some embodiments of the present invention, the adhesive/connecting substance may be a substance that is not affected or substantially affected by water, alkali, and petrochemicals. In some embodiments of the present invention, the adhesive/connecting substance may be used in an amount sufficient to bond/connect effectively to both the flexible membrane 200 and to the various materials employed for the substrate 400. In some embodiments, the bond/connection may remain intact and effective for the useful commercial life of form 100 (e.g., for at least 20, 30, or 30+ pours, etc.). In some embodiments of the present invention, the adhesive includes one-part acrylics, two-part acrylics, epoxies, polyurethanes, phenolics, hot-melt adhesives, polyvinyl acetates, ethylene vinyl acetates, pressure-sensitive adhesives, and/or mixtures thereof.

In some embodiments of the present invention, the flexible membrane 200 is of a design (thickness, material properties, etc.) that allows the flexible membrane to be manipulated to form a curved surface having a radius of about 1 inch.

In some embodiments of the present invention, the flexible membrane 200 may have the adhesive 300 pre-applied at a location other than the location at which the flexible membrane is attached to the substrate 400. By way of example only, and not by way of limitation, some embodiments of the present invention may be practiced by obtaining a roll of flexible substrate having an adhesive attached thereon along with a release film that separates the adhesive from the adjoining section of flexible substrate in the roll. The roll of flexible membrane may be shipped to a site where concrete products will be produced, unrolled at that site, the release film removed to expose the adhesive, and the flexible membrane attached to the substrate without the need to separately apply an adhesive/separately apply relatively substantial amounts of adhesive, etc.

The concrete form 100 may be, by way of example only, attached and secured to a concrete forming frame or otherwise positioned and secured in the desired orientation or alignment in a free-standing configuration using, for example, nails, screws, or clamps. Holes in the form 100 remaining after the nails and screws are removed can be resealed, in the field, with material to restore the form 100 to its original condition.

In some embodiments, the concrete form 100 may be cut or sawed, nailed or screwed into, framed and clamped and otherwise used, handled and stored in the same manner as, and employing the same commercially available tools and equipment and standard industry practices currently employed with, non-metal concrete forming products employed in normal building and construction applications and conditions.

In an another embodiment of the present invention, another flexible membrane may be bonded or otherwise connected to an opposite side of a substrate, thus creating a dual-faced concrete form with a useful commercial life of, by way of example, at least 40, 50, or 60+ pours (i.e., at least 20, 25, 30+ pours respectively) for each face of the dual-faced concrete form when the flexible membrane is applied to that surface. In yet other embodiments of the present invention, a composite material with desirable release characteristics vis-a-vis cured concrete, such as one according to Provisional Application No. 60/559,005, entitled “Release Agent-Free, Multiple-Use, Polymer-Based Composite Materials Employed for Concrete Pouring Forms and Methods of Making and Using Same,” filed Apr. 5, 2004, is connected to the opposite side of the substrate, thus creating a dual-faced concrete form with a useful commercial live as just recited.

In some embodiments of the present invention, the flexible member may be subjected to a surface treatment to improve adhesion to the substrate. The surface treatment may be selected, by way of example only and not by way of limitation, from the group of a corona discharge, a flame treatment, a plasma treatment, and/or combinations thereof.

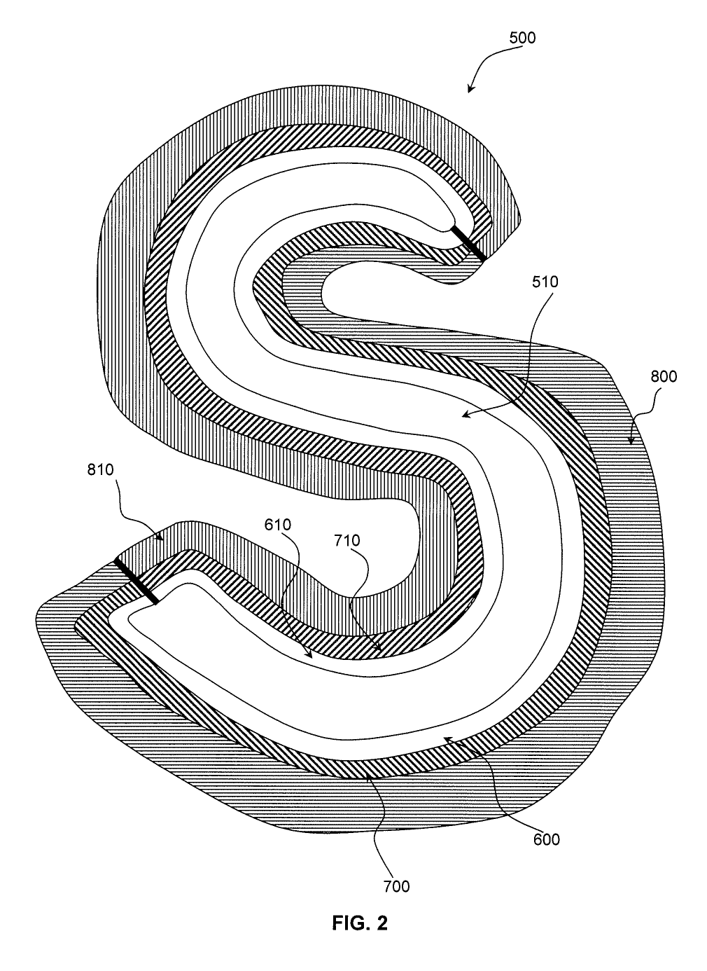

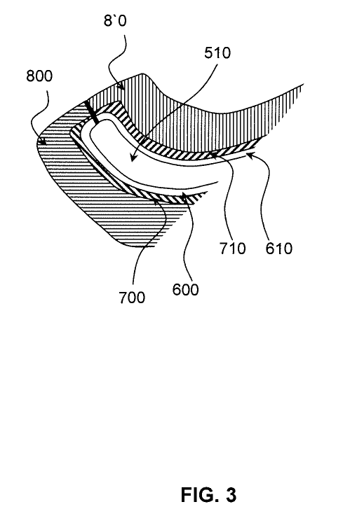

FIGS. 2 and 3 (the latter being a close-up view of the bottom portion of FIG. 2) presents a cross-section of a concrete form 500 in two sections that are brought together according to a further embodiment of the invention, which comprises flexible membranes 600 and 610 adhered to a substrate 800 and 810, respectively, with an adhesive 700 and 710, respectively. FIGS. 2 and 3 depict a concrete form where a concrete product may be formed from the resulting cavity 510 created by bringing elements 600, 700 and 800 together with elements 610, 710 and 810. Such a form 500 may be used to make multiple “copies” of concrete products. In some embodiments of the present invention, the form 500 may be used 20, 25, 30 and/or 30+ times without the need of a release agent. The form 500 may be manufactured by applying a flexible membrane 600/610 to respective substrates 800/810 with respective adhesive layers 700/710, such membranes, adhesives, and substrates being in accordance with those detailed herein, at least in some embodiments of the present invention.

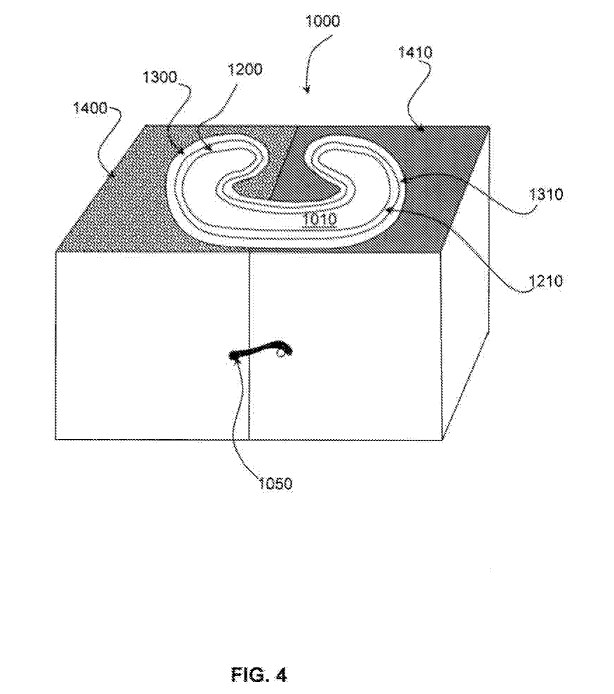

FIG. 4 depicts another embodiment of the present invention, which is a form 1000 for creating a highly curved concrete product in cavity 1010. The form 1000 includes two sections, each of which comprise a substrate (substrates 1400 and 1410), to which a flexible membrane (1200, 1210) may be adhered with an adhesive (1300, 1310). As may be seen, the cavity 1010 may be formed by bringing together the two sections, which may be held in place with lock 1050. Concrete may be poured into the cavity 1010, allowed to cure, and then released from the cavity by releasing lock 1050 and separating the two sections of the form 1000.

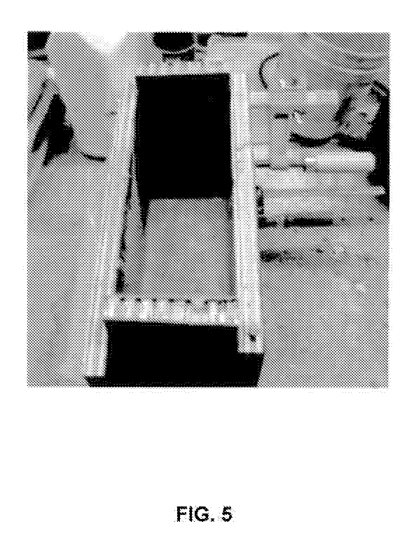

In an exemplary embodiment of the present invention that has been practiced, flexible membranes were bonded to surfaces of celluloid by an adhesive layer, as may be seen in FIG. 5. The resulting form components were used to create a concrete form having a rectangular cavity with internal dimensions of approximately four inches in width, 12 inches in height, and 12 inches in length with the flexible membrane forming the interior surfaces of the two larger sides of the concrete form. The resulting concrete pour form was filled with a concrete composition comprising a very high alkalinity cement mix with various aggregates of various sizes and shapes, including sand and gravel with sharp edges. No form oil or other oils or release agents were applied to the surfaces of the flexible membrane prior to pouring the concrete composition into the concrete form. The concrete in form was vibrated and tamped to remove trapped air and condense the composition in accordance with standard building and construction industry practice. The concrete composition was then cured in place in the container.

When the concrete was cured, the container was then disassembled and the cured concrete block was removed. The flexible membrane forming the interior faces of the walls of the container released easily from the cured concrete block when the laminated panel samples were disassembled and removed from the cured concrete block. The surfaces of the flexible membrane were smooth, and no damage to any of the surfaces of the flexible membrane was observed. Further, any residual concrete mineral dust remaining on the surface of the flexible membrane washed off easily with water.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A concrete form comprising: (i) a rigid substrate having at least one of a flat and curved surface, which are presented to poured concrete, and (ii) a flexible membrane lining at least the one flat or curved surface of the rigid substrate so as to have at least one flat or curved surface due to the respective flat or curved surface of the rigid substrate, at least a portion of the flexible membrane coming into contact with the poured concrete,
whereupon the cured concrete can be separated from the concrete form, in the absence of a release agent, to provide one or more corresponding flat or curved surfaces on the cured concrete, which surfaces require little to no finishing work.

2. The concrete form of claim 1 in which the flexible membrane comprises an elastomer, a vulcanizable elastomer, a vulcanized elastomer, a poly-rubber blend, or mixtures thereof.

3. The concrete form of claim 2 in which the elastomer is selected from the group consisting of a polymer comprising ethylene propylene diene monomers (EPDM), a polymer comprising butylene monomers, a polymer comprising chlorosulfonated polyethylene,and mixtures thereof.

4. The concrete form of claim 1 in which the rigid substrate comprises plywood, carved wood, particle board, oriented strand board, rigid and foamed polymers, metal, celluloid, composite, or combinations thereof.

5. The concrete form of claim 1 in which the rigid substrate is secured to the flexible membrane.

6. The concrete form of claim 1 in which the rigid substrate is bonded to the flexible membrane with an adhesive.

7. The concrete form of claim 1 in which the flexible membrane has a surface energy of less than or approximately equal to
30 dynes/cm.

8. The concrete form of claim 1 in which the flexible membrane has a surface energy of less than or approximately equal to 25 dynes/cm.

9. The concrete form of claim 1 in which exhibits desired release characteristics for at least 20 concrete pours without using a release agent.

10. The concrete form of claim 1 in which exhibits desired release characteristics for at least 30 concrete pours without using a release agent.

11. The concrete form of claim 6 in which the adhesive is selected from the group consisting of one-part acrylics, two-part acrylics, epoxies, polyurethanes, phenolics, hot-melt adhesives, polyvinyl acetates, ethylene vinyl acetates, pressure-sensitive adhesives, and mixtures thereof.

12. The concrete form of claim 1 in which the flexible membrane has a thickness of at least approximately 40 mills.

13. The concrete form of claim 5 in which at least one of a sheet of composite material and a second flexible membrane is bonded to an outside surface of the rigid substrate.

14. A method of forming concrete comprising:
(a) pouring concrete into a concrete form;
(b) allowing the poured concrete to cure; and
(c) separating the concrete form from the cured concrete,
provided that at least a portion of the poured concrete comes into contact with a liner of the concrete form, which liner comprises a flexible membrane.

15. The method of claim 14 in which a surface of the cured concrete, which had been in contact with the liner of the concrete form, requires little to no finishing work.

16. The method of claim 14, wherein the action of pouring concrete into a concrete form, along with the action of providing that at least a portion of the poured concrete comes into contact with a liner of the concrete form that comprises a flexible membrane, is accomplished without applying a release agent.

17. The method of claim 14, wherein the action of pouring concrete into a concrete form, along with the action of providing that at least a portion of the poured concrete comes into contact with a liner of the concrete form that comprises a flexible membrane, is accomplished utilizing a flexible membrane comprising an elastomer, a vulcanizable elastomer, a vulcanized elastomer, a poly-rubber blend, or mixtures thereof.

18. The method of claim 17, wherein the elastomer is selected from the group consisting of a polymer comprising ethylene propylene diene monomers (EPDM), a polymer comprising butylene monomers, a polymer comprising chlorosulfonated polyethylene,and mixtures thereof.

19. The method of claim 14, wherein the action of pouring concrete into a concrete form, along with the action of providing that at least a portion of the poured concrete comes into contact with a liner of the concrete form that comprises a flexible membrane, is accomplished while a rigid substrate is secured to the flexible membrane.

20. The concrete form of claim 19 in which the rigid substrate is bonded to the flexible membrane with an adhesive.

21. A method of repeatedly producing cured concrete products, comprising:
performing the actions of claim 14 to obtain a first cured concrete product; and
repeating the actions of claim 14 at least about 19 times to produce additional cured concrete products, wherein the concrete form of claim exhibits desired release characteristics for at least these repeated actions without using a release agent.

22. A method of repeatedly producing cured concrete products, comprising:
performing the actions of claim 14 to obtain a first cured concrete product; and
repeating the actions of claim 14 at least about 29 times to produce additional cured concrete products, wherein the concrete form of claim exhibits desired release characteristics for at least these repeated actions without using a release agent.

23. A method of manufacturing a concrete form, comprising:
positioning a rigid substrate having at least one of a flat and curved surface which are presented to poured concrete; and
positioning a flexible membrane over at least the one flat or curved surface of the rigid substrate so that the positioned flexible membrane has at least one flat or curved surface due to the respective flat or curved surface of the rigid substrate; wherein
the form is adapted to permit poured concrete to come into contact with at least a portion of the flexible membrane; wherein
the flexible membrane is adapted to remain in contact with the poured concrete at least until the concrete becomes substantially cured concrete; and wherein
the form is adapted so that the substantially cured concrete can be separated from the concrete form, in the absence of a release agent, to provide one or more corresponding flat or curved surfaces on the cured concrete, which surfaces require little to no finishing work.

24. The method of claim 23, wherein the flexible membrane comprises an elastomer, a vulcanizable elastomer, a vulcanized elastomer, a poly-rubber blend, or mixtures thereof.

25. The method of claim 24 in which the elastomer is selected from the group consisting of a polymer comprising ethylene propylene diene monomers (EPDM), a polymer comprising butylene monomers, a polymer comprising chlorosulfonated polyethylene,and mixtures thereof.

26. The method of claim 25, further comprising bonding the rigid substrate to the flexible membrane.

27. The method of claim 26, in which the flexible membrane has a surface energy of less than or approximately equal to 30 dynes/cm.

28. The method of claim 27, wherein the manufactured form is adapted to exhibit desired release characteristics for at least 20 concrete pours and corresponding substantial cures without using a release agent.

29. A method of forming concrete, comprising:
manufacturing a concrete form according to the method of claim 23;
pouring concrete into the manufactured concrete form;
allowing the poured concrete to cure; and
separating the manufactured concrete form from the cured concrete; wherein
at least a portion of the poured concrete comes into contact with the flexible membrane.

30. A method of forming concrete, comprising:
manufacturing a concrete form according to the method of claim 24;
pouring concrete into the manufactured concrete form;
allowing the poured concrete to cure; and
separating the manufactured concrete form from the cured concrete; wherein
at least a portion of the poured concrete comes into contact with the flexible membrane.

31. A method of forming concrete, comprising:
manufacturing a concrete form according to the method of claim 25;
pouring concrete into the manufactured concrete form;
allowing the poured concrete to cure; and
separating the manufactured concrete form from the cured concrete; wherein
at least a portion of the poured concrete comes into contact with the flexible membrane.

32. The method of claim 29 in which a surface of the cured concrete, which had been in contact with the liner of the concrete form, requires little to no finishing work.

33. The method of claim 29, wherein the action of pouring concrete into a concrete form, along with the action of providing that at least a portion of the poured concrete comes into contact with a liner of the concrete form that comprises a flexible membrane, is accomplished without applying a release agent.
